(19) United States
(12) Patent Application Publication
(10) Pub. No.: US 2007/0239993 A1
(43) Pub. Date: Oct. 11, 2007

(54) System and method for comparing similarity of computer programs

(75) Inventors: Oleg Sokolsky, Haverford, PA (US); Insup Lee, Newtown Square, PA (US); Sampath Kannan, Philadelphia, PA (US)

Correspondence Address: SYNNESTVEDT & LECHNER, LLP, 1101 MARKET STREET, 26TH FLOOR, PHILADELPHIA, PA, 19107-2950, US

(73) Assignee: The Trustees of the University of Pennsylvania, Philadelphia, PA (US)

(21) Appl. No.: 11/378,958

(22) Filed: Mar. 17, 2006

Related U.S. Application Data
(60) Provisional application No. 60/783,444, filed on Mar. 17, 2006.

(51) Int. Cl. H04L 9/32

(52) U.S. Cl. 713/188

(57) ABSTRACT

Similarity between the distinct documents/programs is determined by comparing their respective control flow or other labeled transition graphs. The determination of similarity involves creating a combined measure of similarity based in part on a measure of local similarity between the graphs and in part on a measure of step similarity between the graphs. Local and step similarity are computed conventionally. A linear programming problem involving the local and step similarity measures is formulated and solved conventionally to yield an overall similarity score representing similarity of the graphs as wholes. The score is compared to a predetermined threshold and an alert is issued if the score exceeds the threshold. The alert allows for further action, such as further examination of a particular computer program if it is believed to be a possible virus in view of a high similarity score resulting from comparison to a known computer virus.

### CROSS-REFERENCE TO RELATED APPLICATION

This application claims the benefit of U.S. Provisional Patent Application No. 60/______, titled A Method for Computing Similarity Between Computer Programs, filed concurrently herewith on Mar. 17, 2006, (Attorney Docket No. S&L P31369 USA), the entire disclosure of which is hereby incorporated herein by reference.

### STATEMENT OF GOVERNMENT INTEREST

This invention was made with government support under ONR N00014-04-1-0735 PL:Kannan awarded by the Office of Naval Research. The government has certain rights in the invention.

### FIELD OF THE INVENTION

The present invention relates generally to analytical computer software tools, and more particularly to a system and method for comparing similarity of computer programs, which has been found particularly useful to identify new variants of computer virus programs.

### DISCUSSION OF RELATED ART

Generally speaking, computer viruses are software programs designed to perform tasks that are not intended to be performed by the owner/user of the computer, e.g., to delete or corrupt data, to record and communicate confidential information, and to “spread” itself by creating copies of itself on other computers. Such computer viruses, and the threat of such computer viruses, are commonplace to most computer users today.

Formerly, a new computer virus program could be created only by an experienced computer programmer having extensive knowledge of operating system and application software, and only after a significant amount of development time and effort. Accordingly, new virus programs tended to appear at a relatively low rate. More recently, the community of virus developers has become more sophisticated, and there are now virus development software components and virus development toolkits that can be readily accessed via the Internet. Accordingly, a new virus program can be created from existing software modules by a person having significantly less computer programming skill and knowledge. As a result, new computer virus programs now appear at a much higher rate, with large numbers of new virus programs appearing on a weekly basis.

Various forms of virus-detection software are commercially available. Exemplary virus-detection software includes Symantec™ Anti-Virus software sold by Symantec Corporation of Cupertino, Calif., and McAfee® VirusScan® sold by McAfee, Inc of Santa Clara, Calif. These virus-detection software packages are typical of convention virus-detection software in that they use conventional signature-based detection techniques. More specifically, after a particular computer virus program is identified, that virus program is analyzed to identify a sequence of bits that is present in the virus program's code and that is believed to uniquely identify that particular computer virus program. That sequence of bits is taken to be the virus program's “signature.” Subsequently, a suspected virus program is scanned for the known signature, and is determined to be a virus if it contains the signature, i.e. the exact same sequence of bits. Such signature-based recognition techniques are ineffective for identifying variants of computer virus programs, which are highly unlikely to include the exact same sequence of bits, even if they perform similar functions. Use of signature-based techniques is overly burdensome for the high rate of new virus proliferation that presently exists.

### SUMMARY OF THE INVENTION

As an alternative to signature-based computer program identification and detection, the present invention provides a system and method that compares computer programs to identify in a new computer program one or more similarities to a known computer virus program. More specifically, the present invention uses an automated comparison to identify similarities between a new computer program and a known virus program that result from use of the same software development toolkit. If a known virus is developed using a known virus toolkit, and a new computer program is found to have similarities to the known virus, resulting from use of the same known virus toolkit, then it is concluded that the new computer program is likely a computer virus and it is flagged for further consideration.

More specifically, the present invention involves some analyzing a reference computer program, such as a known virus program, to extract its control flow graph, and analyzing a subject computer program to extract its control flow graph. Control flow graphs are directed rooted graphs, including nodes, which represent states, and edges, which represent processing steps. Each of the nodes and edges is labeled, as well-known in the art for control flow graphs. For example, these data structures can be created by most existing high level language compilers, or can be extracted from the executable code of the program. These control flow graphs can also be defined at the object code level. The labels of the nodes and edges are code fragments.

Consistent with the present invention, the control flow graphs are then analyzed to determine a degree of similarity between the control flow graphs. The determination of similarity involves creating a combined measure of similarity based in part on a measure of local similarity and in part on a measure of step similarity. Local similarity reflects similarity between node labels of the control flow graphs. Local similarity can be computed in a variety of known, suitable fashions. Step similarity reflects similarity of the two nodes to similarities of their successor nodes. More specifically, similarity is analyzed mathematically by a set of recursive equations that relates similarities of nodes to their local similarities and to the similarities of adjacent nodes. The recursive nature of the equations accounts for the successor nodes outgoing edges as well as the successor nodes successor nodes etc.

These equations are used to create a linear programming problem, which can be solved by freely available linear programming problem solving computer software. These measures of local similarity and step similarity are combined, and weighted, to give an overall similarity score in numeric form. Thus, the similarity between the initial nodes of the two control flow graphs, taking into account successor nodes and outgoing edges, is taken to be the similarity measure for the graphs as wholes, and thus the computer programs as wholes. The score is then compared to a predetermined threshold and an alert is issued if the score exceeds the threshold. The alert allows for further action, such as further examination of a particular computer program if it is believed to be a possible virus in view of a high similarity score resulting from comparison to a known computer virus.

While the present invention is useful in comparing computer programs, and thus comparing suspect computer programs to known virus computer programs to detect new computer viruses, the present invention is equally applicable for other purposes. For example, the present invention can be used in any application in which numerical comparison of two graphs is desired. For example, labeled graph data structures may be produced for textual documents, and a similar approach may be used to compare the graphs for the purpose of identifying duplications in literature citation databases or functionally similar genes in bioinformatics applications.

### BRIEF DESCRIPTION OF THE DRAWINGS

The present invention will now be described by way of example with reference to the following drawings in which:

FIG. 1 is a flow diagram illustrating exemplary computer program comparison in accordance with an embodiment of the present invention;

FIG. 2 is a flow diagram illustrating exemplary similarity determination of FIG. 1;

FIGS. 3 and 4 are control flow graphs of exemplary reference and subject computer programs, respectively;

FIG. 5 illustrates an exemplary linear programming problem for the exemplaroy control flow graphs of FIGS. 3 and 4; and

FIG. 6 is a block diagram of an exemplary computer system for use in accordance with the present invention.

### DETAILED DESCRIPTION

The present invention provides a system and method for comparing computer programs, document citation databases, gene co-expression networks, or any other computer document or file that can be represented as a labeled rooted graph or a labeled transition system. For illustrative purposes, the discussion below is provided in the context of comparing computer programs, which is useful, for example, to identify new computer virus programs.

As an alternative to signature-based computer program identification and detection, the present invention provides a system and method that compares computer programs to identify in a new computer program one or more similarities to a known computer virus program. Generally speaking, the comparison is used to identify as a potential new computer virus program any computer program having sufficient similarity to a known computer virus program. More specifically, the present invention uses an automated comparison to identify similarities between a new computer program and a known virus computer program that result from use of the same software development toolkit. If a known virus is developed using a known virus toolkit, and a new computer program is found to have similarities to the known virus, resulting from use of the same known virus toolkit, then it is concluded that the new computer program is likely a computer virus and it is flagged for further consideration.

More specifically, the present invention involves analyzing a reference computer program, such as a known virus program, to extract its control flow graph, and analyzing a subject computer program to extract its control flow graph. Control flow graphs are directed rooted graphs, including nodes representing states, and edges representing processing steps. Each of the nodes and edges is labeled, as well-known in the art for control flow graphs. For example, these data structures can be created by most existing high level language compilers, or can be extracted from the executable code of the program. These control flow graphs can also be defined at the object code level. The labels of the nodes and edges are code fragments.

Consistent with the present invention, the control flow graphs are then analyzed to determine a degree of similarity between the control flow graphs. The determination of similarity involves creating a combined measure of similarity based in part on a measure of local similarity and in part on a measure of step similarity. Local similarity reflects similarity between node labels of the control flow graphs. Local similarity can be computed in a variety of known, suitable fashions. Step similarity reflects similarity of the two nodes to similarities of their successor nodes. More specifically, similarity is analyzed mathematically by a set of recursive equations that relates similarities of nodes to their local similarities and to the similarities of adjacent nodes. The recursive nature of the equations accounts for the successor nodes outgoing edges as well as the successor nodes successor nodes etc.

These equations are used to create a linear programming problem, which can be solved by freely or commercially available linear programming problem solving computer software. These measures of local similarity and step similarity are combined, and weighted, to give an overall similarity score, preferably in numeric form. Thus, the similarity between the initial nodes of the two control flow graphs, taking into account successor nodes and outgoing edges, is taken to be the similarity measure for the graphs as wholes, and thus the computer programs as wholes. The score is then compared to a predetermined threshold and an alert is issued if the score exceeds the threshold. The alert allows for further action, such as further examination of a particular computer program if it is believed to be a possible virus in view of a high similarity score resulting from comparison to a known computer virus.

While the present invention is useful in comparing computer programs, and thus comparing suspect computer programs to known virus computer programs to detect new computer viruses, the present invention is equally applicable for other purposes. For example, the present invention can be used in any application in which numerical comparison of two graphs is desired. Two examples of the applications that can yield labeled graph data structures are databases of literature citations (such as the widely used CiteSeer database), and gene co-expression networks used in bioinformatics databases.

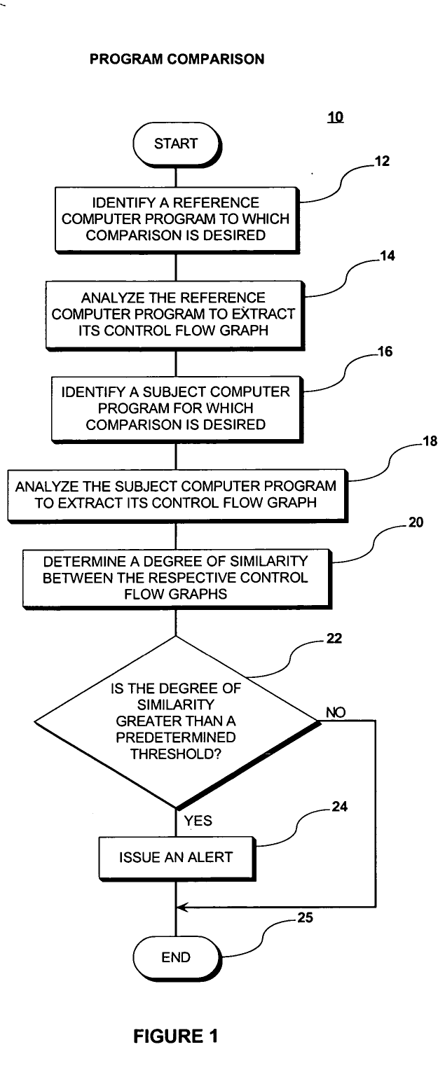

Referring now to FIG. 1, an exemplary flow diagram 10 is shown illustrating exemplary computer program comparison in accordance with an embodiment of the present invention. The begins with identifying of a reference computer program to which comparison is desired, as shown at step 12. For example, the reference computer program can be a known virus program maintained in a database of known virus programs stored in memory of a computer system.

The reference computer program is then analyzed to extract its control flow graph, as shown at step 14 as discussed above, extraction of a control flow graph from an executable computer program can be performed in an automated fashion by existing and/or commercially available high level language compiler programs, such as the GCC compiler for programs written in the C programming language, or can be extracted directly from the executable code of the program using commercially available tools, such as CodeSurfer/x86 by Gramma Technologies. Preferably, steps 12 and 14 are performed in advance such that the control flow graph can be quickly referenced subsequently for comparison purposes.

Next, a subject computer program for which comparison is desired is identified, as shown at step 16. The subject computer program can be any program for which comparison is desired. For example, this may be performed by identifying an electronic file attached to an e-mail message at a PC configured as a client device in a client/server network environment. Alternatively, this may be performed at a central location by anti-virus service vendor, such as Symantec Corp., McAfee Corp. or others distributing virus identification software, such that they may issue updated anti-virus data files to PCs using their anti-virus software, distribution of such known virus data files being known in the art.

The subject computer program is then analyzed to attract its respective control flow graph, shown at step 18. This may be performed in a manner similar to that described above with respect to step 14. This step may be performed from time to time, as new subject computer programs are identified, for comparison against any previously compiled database of reference computer programs.

A degree of similarity between their respective control flow graphs of the reference computer program and the subject computer program is then determined, as shown at step 20. The similarity may be determined in any suitable manner. For example, comparison may be made only to determine whether the respective control flow graphs are identical, the degree reflecting only identity or non-identity. In a preferred embodiment, the degree reflects and relative degree of similarity within a range of similarity from a lower bound of complete dissimilarity (e.g., 0) to an upper bound of identity (e.g., 1). Preferably the degree is expressed in numeric decimal form between 0 and 1.

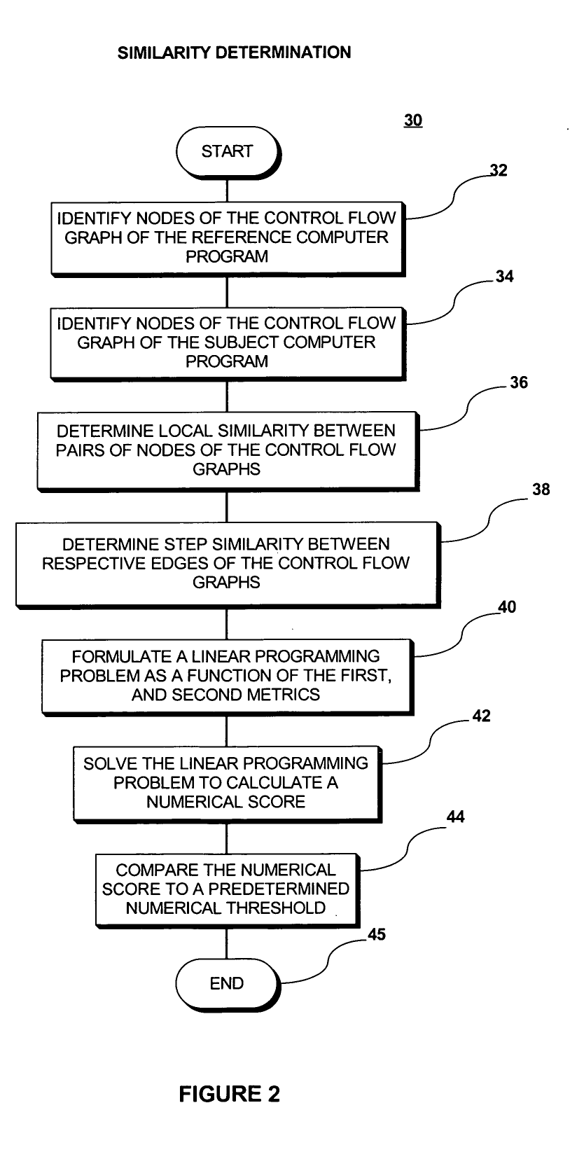

FIG. 2 is a flow diagram illustrating exemplary similarity determination for step 20 of FIG. 1, as discussed in greater detail below.

Referring again to FIG. 1, it is determined whether the degree of similarity is greater than a predetermined threshold, as shown at step 22. Preferably, the threshold is expressed in numeric decimal form between 0 and 1. The threshold may be an arbitrary, or preferably empirically-based, value that is provided as a parameter of the comparison process to fine tune a level of similarity that will be considered actionable.

If the degree of similarity between the subject computer program and the reference computer program is not greater than the predetermined threshold then the method ends, as shown at step 25.

If, however, the degree of similarity between the subject computer program and the reference computer program is greater than the predetermined threshold then the method ends with issuance of an alert, as shown at steps 24 and 25. for example, the alert may include flagging the subject computer program for further analysis or review to confirm that it is a virus, or may include adding the subject computer program and/or its control flow graph to a database of known computer virus programs, a refusal to execute the subject program, a refusal to transmit the subject program, or any other or desired action.

By way of further example, in the context of comparison of entries in a literature citation database, the alert may take the form of an automatically generated e-mail message to the database administrator, for example indicating that potentially duplicate entries were found. Optionally, in the case of very high similarity, a service routine is automatically invoked to scan the database and automatically remove one of the duplicate entries, and to replace references to it with references to the other entry in the identified duplicate pair.

The method may subsequently be repeated for a next reference computer program for the same subject computer program, or for a next subject computer program for the same reference computer program.

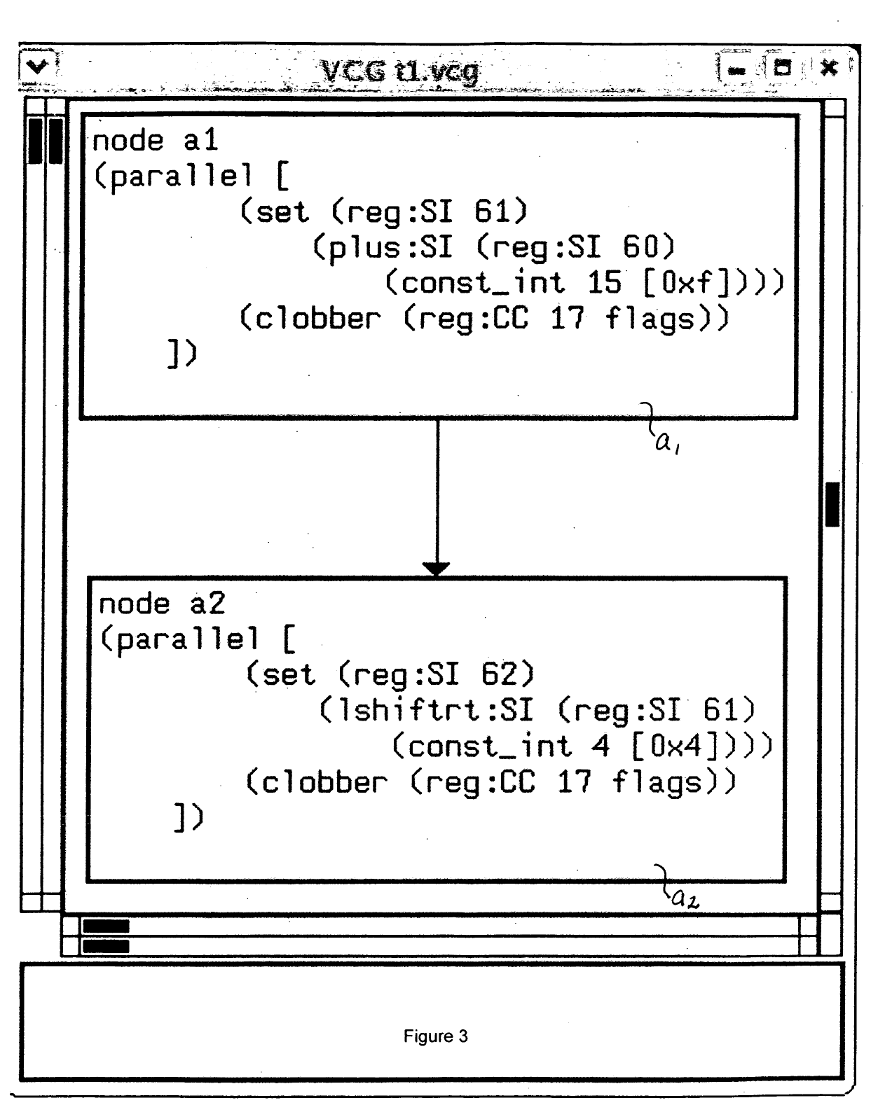

Referring now to FIG. 2, a flow diagram 30 is shown illustrating exemplary similarity determination for step 20 of FIG. 1. As shown in FIG. 2, the similarity determination begins with identification of the first and second nodes of the control flow graph of the reference computer program, as shown at step 32. A control flow graph of an exemplary reference computer program is shown in FIG. 3. For illustrative purposes it is considered that the first node is the initial node of the reference computer program's control flow graph, namely a₁, and the second node is the next sequential node of the graph, namely a₂.

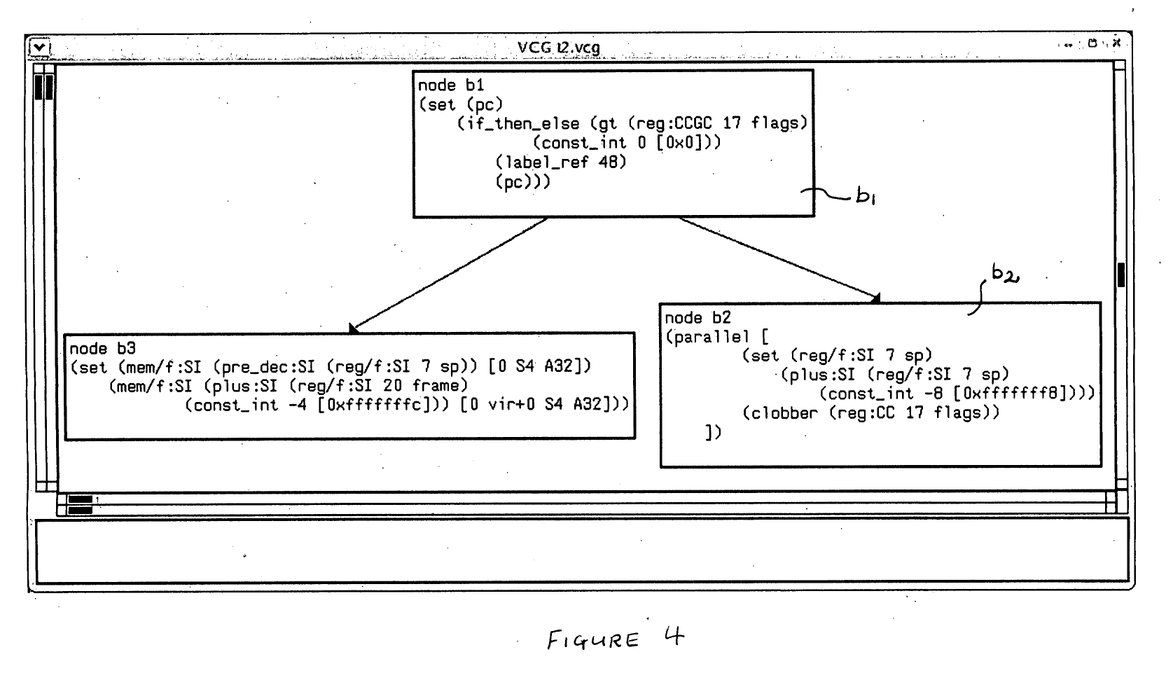

Next, first and second nodes of the control flow graph of the subject computer program are identified, as shown at step 34. A control flow graph of an exemplary subject computer program is shown in FIG. 4. For illustrative purposes, it is considered that the first and second nodes of the subject computer program are b₁, b₂, respectively.

Local similarity between pairs of nodes, preferably every pair, in the two graphs is then determined, as shown in step 36. Local similarity can be determined in any suitable manner, and various techniques are known in the art for this purpose. Conceptually, local similarity is determined by applying a local similarity function N to each pair of nodes. Local similarity of the nodes in the two graphs is expressed in decimal form and is used as a first metric.

Next, step similarity between respective edges, preferably every pair of edges, in the two graphs is determined, as shown at step 38. Conceptually, step similarity is determined by applying a step similarity function L to a given set of edges between nodes. Step similarity can be determined in any suitable manner and various techniques are known in the art for this purpose. Step similarity between edges is then expressed in decimal form as a second metric.

Next, local and step similarities are combined together into an overall similarity score for the two graphs. The similarity score is determined by relating together local similarity measures of pairs of adjacent nodes together with the step similarity measure of the edges connecting these adjacent nodes, yielding a composite similarity score that is a function of the individual similarity scores. Thus, the score computed for the pair of the initial nodes is taken as the similarity score for the two graphs overall. This function is called p-weighted quantitative simulation (q-simulation), where p is a parameter, which is a number between 0 and 1. It is represented by the following recurrence equation:

$${Q}_{p} ( s , t ) = \{ \begin{matrix}N ( s , t ) & s -> / \\ ( 1 - p ) \cdot N ( s , t ) + \frac{p}{\vert s {->}^{a} {s}^{′} \vert} \cdot {\sum }_{s {->}^{a} {s}^{′}} {max}_{t {->}^{b} {t}^{′}} ( L ( a , b ) \cdot {Q}_{p} ( {s}^{′} , {t}^{′} ) ) & otherwise\end{matrix}$$

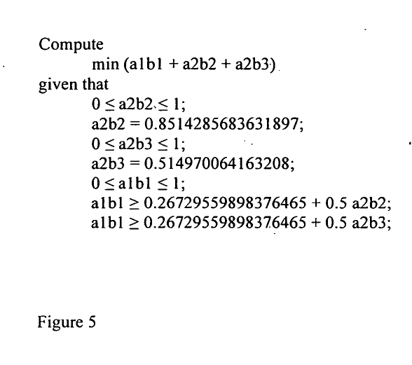

From this recurrence, a linear programming problem is formulated as the function of the first and second metrics, using the parameter p that reflects the relative weight given to the two metrics, as shown at step 40. Given the exemplary control flow graphs in FIGS. 3 and 4, the linear programming problem is illustrated in FIG. 5 for an exemplary value p=0.5, in which equal weight is given to each metric. Local similarities between nodes are obtained by comparing node labels as strings of letters for the purpose of this example. Step similarity between every two nodes is considered to be 1 for the purpose of this example.

The linear programming problem is then solved, as shown at step 42. Conventional software is commercially or otherwise available for solving such linear programming problems. For example, lp_solve linear programming solver may be used for this purpose. This creates a score, preferably in decimal format, reflecting a degree of similarity between every pair of nodes in the control flow graphs, taking into consideration both local and step similarities.

The score is then compared to a predetermined numerical threshold, shown at step and 44, and the method ends, as shown at step 45.

It will be appreciated that this simplified example includes only two nodes, and that as a practical matter, control flow graphs of computer programs include multiple nodes, multiple edges, and may include multiple branching paths from a single node, and thus are considerably more complex than this simple illustrative example.

Preferably local similarity between the nodes, and step similarity of edges, is determined as described in the mathematical equations below. These equations take as the similarity for the control flow graphs, as wholes, the similarity between the initial nodes of the graphs, but examine the initial nodes, and the sequential nodes and edges issuing from the initial nodes in determining the similarity of the initial nodes. These equations are suitable for actual control flow graphs of computer programs that are considerably more complex than the illustrative example above.

Computer Platform

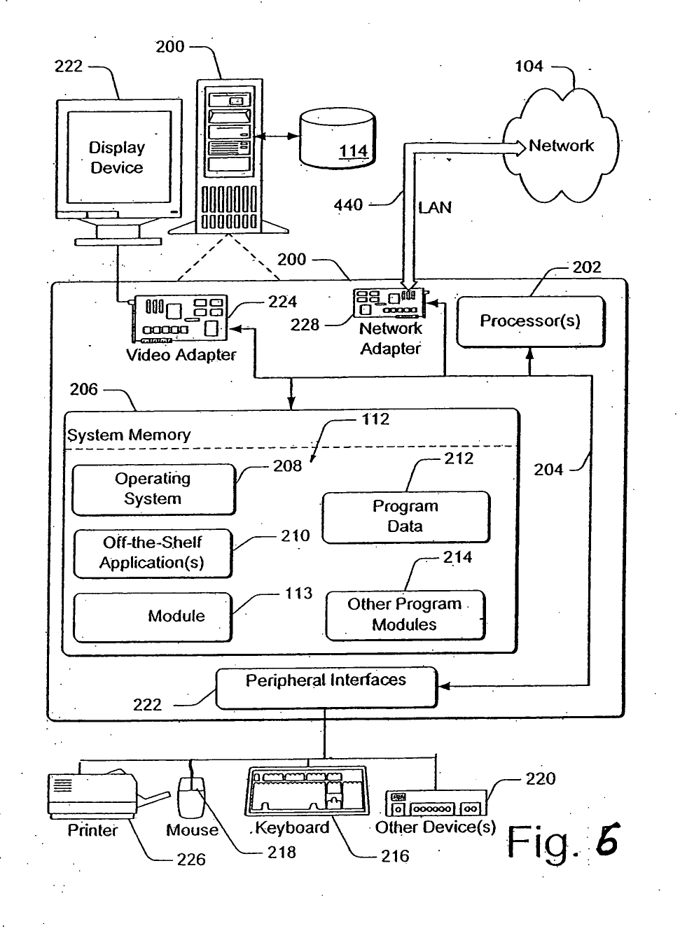

FIG. 6 is a block diagram showing an example computer 200 within which various functionalities described herein can be fully or partially implemented. Computer 200 can function as a server, a personal computer, a mainframe, or various other types of computing devices. It is noted that computer 200 is only one example of computer environment and is not intended to suggest any limitation as the scope or use or functionality of the computer and network architectures. Neither should the example computer be interpreted as having any dependency or requirement relating to any one or combination of components illustrated in FIG. 6.

Computer 200 may include one or more processors 202 coupled to a bus 204. Bus 204 represents one or more of any variety of bus structures and architectures and may also include one or more point-to-point connections.

Computer 200 may also include or have access to memory 206, which represents a variety of computer readable media. Such media can be any available media that is accessible by processor(s) 202 and includes both volatile and non-volatile media, removable and non-removable media. For instance, memory 206 may include computer readable media in the form of volatile memory, such as random access memory (RAM) and/or non-volatile memory in the form of read only memory (ROM). In terms of removable/non-removable storage media or memory media, memory 206 may include a hard disk, a magnetic disk, a floppy disk, an optical disk drive, CD-ROM, flash memory, etc.

Any number of program modules 112 can be stored in memory 206, including by way of example, an operating system 208, off-the-shelf applications 210 (such as e-mail programs, browsers, etc.), program data 212, the software application at least partially implementing the present invention being referred to as reference number 113 in FIG. 6, and other modules 214. Memory 206 may also include one or more persistent stores 114 containing data and information enabling functionality associated with program modules 112.

A user can enter commands and information into computer 200 via input devices such as a keyboard 216 and a pointing device 218 (e.g., a “mouse”). Other device(s) 220 (not shown specifically) may include a microphone, joystick, game pad, serial port, etc. These and other input devices are connected to bus 204 via peripheral interfaces 222, such as a parallel port, game port, universal serial bus (USB), etc.

A display device 222 can also be connected to computer 200 via an interface, such as video adapter 224. In addition to display device 222, other output peripheral devices can include components such as speakers (not shown), or a printer 226.

Computer 200 can operate in a networked environment or point-to-point environment, using logical connections to one or more remote computers. The remote computers may be personal computers, servers, routers, or peer devices. A network interface adapter 228 may provide access to network 104, such as when network is implemented as a local area network (LAN), or wide area network (WAN), etc.

In a network environment, some or all of the program modules 112 executed by computer 200 may be retrieved from another computing device coupled to the network. For purposes of illustration, the operating program module 113 and other executable program components, such as the operating system, are illustrated herein as discrete blocks, although it is recognized that such programs and components reside at various times in different storage components remote or local, and are executed by processor(s) 202 of computer 200 or remote computers.

Program Module

Techniques and functionality described herein may be provided in the general context of computer-executable instructions, such as program modules, executed by one or more computers (one or more processors) or other devices. Generally, program modules include routines, programs, objects, components, data structures, logic, etc. that perform particular tasks or implement particular abstract data types. Typically, the functionality of the program modules may be combined or distributed as desired in various embodiments, to carry out one or more of the methods, or combinations of steps of the methods, described herein. It is noted that a portion of a program module may reside on one or more computers operating in a system.

An implementation of these modules and techniques may be stored on or transmitted across some form of computer readable media. Computer readable media can be any available media that can be accessed by a computer. By way of example, and not limitation, computer readable media may comprise volatile and non-volatile media, or technology for storing computer readable instructions, data structures, program modules, or other data.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A computer-implemented method for identifying a new computer virus program, the method comprising a computer system:
identifying a reference computer program, said reference computer program being capable of expression in a control flow graph, said control flow graph comprising a first plurality of nodes interconnected by a first plurality of edges, said reference computer program being a computer virus program;
identifying a subject computer program, said subject computer program being capable of expression in a respective control flow graph, said respective control flow graph comprising a second plurality of nodes interconnected by a second plurality of edges;
comparing said control flow graph of said reference computer program to said control flow graph of said subject computer program to identify a degree of similarity between said control flow graphs, said degree of similarity being within a range of degrees of similarity having a lower bound and an upper bound;
comparing said degree of similarity to a predetermined similarity threshold within said range; and
determining whether said subject computer program is a computer virus, said subject computer program being determined to be a computer virus if said degree of similarity exceeds said similarity threshold.

2. A computer-implemented method for identifying a new computer virus program, the method comprising a computer system:
identifying a reference computer program, said reference computer program being a computer virus program;
identifying a subject computer program;
comparing said reference computer program to said subject computer program to identify a degree of similarity between functions of said computer programs, said degree of similarity being within a range of degrees of similarity having a lower bound and an upper bound;
comparing said degree of similarity to a predetermined similarity threshold within said range; and
determining whether said subject computer program is a computer virus, said subject computer program being determined to be a computer virus if said degree of similarity exceeds said similarity threshold.

3. The method of claim 2, wherein the degree of similarity between functions of said computer programs is determined by comparing computer programming code.

4. The method of claim 3, wherein said degree of similarity is greater than the lower bound and less than the upper bound.

5. The method of claim 2, wherein the degree of similarity between functions of said computer programs is determined by comparing respective control flow graphs of said computer programs.

6. The method of claim 2, wherein the degree of similarity between functions of said computer programs is determined as a mathematical function of local similarity and step similarity.

7. The method of claim 6, wherein local similarity and step similarity are determined by comparing respective control flow graphs of said computer programs.

8. The method of claim 7, wherein local similarity reflects similarity of labels of nodes of the respective control flow graphs.

9. The method of claim 8, wherein step similarity reflects similarity of labels of edges between nodes of the respective control flow graphs.

10. The method of claim 9, wherein each label comprises computer programming code.

11. The method of claim 7, wherein the function is a weighted sum of local similarity and step similarity.

12. The method of claim 2, wherein the degree of similarity between functions of said computer programs is determined as a function of local similarity of respective first states of the computer programs, similarity of respective second states of the computer programs, and similarity of respective steps between respective first states and respective second states.

13. The method of claim 2, wherein the degree of similarity between functions of said computer programs is determined by solving an instance of a linear programming problem.

14. The method of claim 2, wherein the degree of similar between functions of said computer programs is given by the following equation:
$${Q}_{p} ( s , t ) = \{ \begin{matrix}N ( s , t ) & s -> / \\ ( 1 - p ) \cdot N ( s , t ) + \frac{p}{\vert s {->}^{a} {s}^{′} \vert} \cdot {\sum }_{s {->}^{a} {s}^{′}} {max}_{t {->}^{b} {t}^{′}} ( L ( a , b ) \cdot {Q}_{p} ( {s}^{′} , {t}^{′} ) ) & otherwise\end{matrix}$$

15. A computer-implemented method for identifying similarity comprising:
identifying a reference document, said reference document being capable of expression in a labeled transition system, said labeled transition system comprising a first plurality of nodes interconnected by a first plurality of edges
identifying a subject document, said subject document being capable of expression in a respective labeled transition system, said respective labeled transition system comprising a second plurality of nodes interconnected by a second plurality of edges;
comparing said labeled transition system of said reference document to said labeled transition system of said subject document to identify a degree of similarity between said control flow graphs, said degree of similarity being within a range of degrees of similarity having a lower bound and an upper bound;
comparing said degree of similarity to a predetermined similarity threshold within said range; and
determining whether said subject document is deemed similar to said reference document, said subject document being determined to be similar if said degree of similarity exceeds said similarity threshold.

16. The method of claim 15, wherein each of said reference document and said subject document comprises a respective computer program.

17. The method of claim 16, wherein said reference document comprises a computer virus program.

18. The method of claim 15, wherein each of said reference document and said subject document comprises a respective textual documents.

19. The method of claim 15, wherein said similarity is used to identify duplications in a literature citation database.

20. The method of claim 15, wherein said similarity is used to identify functionally similar genes.

21. A computerized processing system for determining similarity, said system comprising:
a processor;
a memory operatively connected to said processor;
instructions stored in said memory and executable by said processor to carry out the method of claim 1.

22. A computer program product embodied on one or more computer-readable media, the computer program product comprising computer readable program code configured to carry out the method of claim 1.

23. A computerized processing system for determining similarity, said system comprising:
a processor;
a memory operatively connected to said processor;
instructions stored in said memory and executable by said processor to carry out the method of claim 2.

24. A computer program product embodied on one or more computer-readable media, the computer program product comprising computer readable program code configured to carry out the method of claim 2.

25. A computerized processing system for determining similarity, said system comprising:
a processor;
a memory operatively connected to said processor;
instructions stored in said memory and executable by said processor to carry out the method of claim 15.

26. A computer program product embodied on one or more computer-readable media, the computer program product comprising computer readable program code configured to carry out the method of claim 15.
